(19) United States
(12) Patent Application Publication
(10) Pub. No.: US 2005/0060532 A1
(43) Pub. Date: Mar. 17, 2005

(54) Method and apparatus for automated persona switching for electronic mobile devices

(75) Inventors: Jheroen P. Dorenbosch, Paradise, TX (US); Anand B. Alen, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/662,569

(22) Filed: Sep. 15, 2003

(51) Int. Cl. G06F 1/24

(52) U.S. Cl. 713/100; 709/200

(57) ABSTRACT

A method of operating an electronic device (100) without the intervention of a user comprising setting a first persona for the electronic device, the first persona defining the parameter values for one or more persona parameters; determining a current environment of the electronic device; and switching to a second persona for the electronic device based upon the current environment of the electronic device, the second persona defining different parameter values for the one or more persona parameters. A software program stored on a computer readable medium comprising a persona manager module (500) for entering persona parameter values associated with a plurality of personas stored on the computer readable medium; and a persona activator module (502) for determining a current environment and activating one of the plurality of personas based the current environment.

### FIELD OF THE INVENTION

The present invention relates generally to electronic mobile devices. More specifically, the present invention relates to electronic mobile devices that are used in multiple environments.

### BACKGROUND

Mobile electronic devices are used by many people in everyday activities. For example, mobile electronic devices can include devices such as a personal digital assistant (PDA), lap top computers, cell phones, and two-way pagers. Even cars may be considered a mobile electronic device. These devices are capable of or can be configured to connect to multiple networks, e.g., a telephony network, the Internet (or other extranet), a local area network (LAN), a wireless wide area network (WWAN), 3G or 4G WWAN that supports packet data, a hot spot, a wireless home network, a wireless local area network (WLAN), a cellular phone network, and so forth. Furthermore, with a continuing advancement in wireless data speeds and technologies such as Bluetooth and WiFi, seamless mobility devices (SMDs) are going to be more common place. A seamless mobility device is able to change between networks without the user having to direct the device to do so. Seamless mobility devices are one more example of a mobile electronic device.

As the seamless mobility devices and multi-mode devices (i.e., electronic devices that can connect to multiple networks or other electronic devices) become commonplace and people use the same device in the home, the office, while traveling and other places, the need for a design that enables the device to be efficiently used in several locations becomes more desirable. Many people have different devices for use at home and at work. For example, people will have a work computer and a home computer because the needs and applications that are used on each are greatly different. Another example is people will have a work phone and a home phone. This is a problem as electronic devices are not cheap. Therefore it would be desirable to reduce the number of devices a single user may want to have. One problem with having fewer devices is that generally a user will have a device configured for a specific use. For example, a laptop computer used for work may have different applications and preferences than a laptop used mainly for personal use. Trying to optimize one laptop for convenient use in both environments can be problematic for the user.

### BRIEF DESCRIPTION OF THE DRAWINGS

The features and advantages of the present invention will be more apparent from the following description thereof, presented in conjunction with the following drawings wherein:

FIG. 1 is a block diagram illustrating an electronic mobile device;

FIG. 2 is a block diagram illustrating different networks and devices an electronic mobile device can be connected with;

FIG. 3 is a diagram illustrating a mobile device connected to different cell towers at different locations;

FIG. 4 is a flow diagram illustrating a method of switching personas;

FIG. 5 is a block diagram illustrating software modules that may be present on a mobile device; and

FIG. 6 is a flow diagram illustrating a method in accordance with a preferred embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

The following description is not to be taken in a limiting sense, but is made merely for the purpose of describing the general principles of the invention. The scope of the invention should be determined with reference to the claims.

One embodiment can be characterized as a method of operating an electronic device without the intervention of a user comprising setting a first persona for the electronic device, the first persona defining the parameter values for one or more persona parameters; determining a current environment of the electronic device; and switching to a second persona for the electronic device based upon the current environment of the electronic device, the second persona defining different parameter values for the one or more persona parameters.

Another embodiment provides a software program stored on a computer readable medium comprising a persona manager module for entering persona parameter values associated with a plurality of personas stored on the computer readable medium; and a persona activator module for determining a current environment and activating one of the plurality of personas based the current environment.

A further embodiment may be characterized as an electronic device comprising means for setting a first persona for the electronic device, the first persona defining the parameter values for one or more persona parameters; means for determining a current environment of the electronic device; and means for switching to a second persona for the electronic device based upon the current environment of the electronic device, the second persona defining different parameter values for the one or more persona parameters.

In accordance with these embodiments and variations thereof, a user of an electronic device is able to conveniently use a device that can be re-configured depending upon the situation in which the device is being used. Moreover, the configuration is done automatically, without the intervention of the user. This allows a user to have a more user friendly electronic device or alternatively to use one electronic device when previously the user may have had separate electronic devices for the different situations. Additionally, a user will be able to more fully utilize the features of a device because they are readily available when the user is most likely to need them, thus promoting the use of the different features of the electronic device.

One prior design that is related to a persona is that of a user profile that can be used on an electronic device like a Personal Computer. Each user of the device can define a single profile for that user. The user's profile defines the user's customized device appearance. This is done by setting parameter values for one or more profile parameters that determine the look and feel of the user interface of the device and that determine which data that will be used by the applications on the device, when executed by the user. For a user to change to the user's profile, the user must log into the electronic device. The device then retrieves the values of the profile parameters for the user and customizes the user interface and the application data for that user. It is well know how a user can define, modify and save a profile.

Likewise, a persona defines the parameter values for one or more persona parameters that determine the look and feel of the user interface of an electronic device and determine which data will be used by the applications on the electronic device. However, a user of the electronic device can have a plurality of personas.

In one embodiment, the user can define the different personas by association one or more persona parameters with the persona and setting values for those one or more persona parameters. The user can also assign names and/or icons to the defined personas and select the default persona. If the user also has a profile one the electronic device, preferably the default persona uses values for its persona parameters that are to the values of the corresponding profile parameters in the user's profile. The persona definition (the values for the one or more persona parameters associated with the persona) can be stored on the electronic device or on an external device. Examples of different personas can be a professional persona and a leisure persona.

A user can also import a persona definition from another device and from a server on the network. A persona may have an expiration time or date, after which time the persona can no longer be used on the electronic device. When a persona expires, the device will use the default persona, use the most-recently used persona or switch to another persona that is appropriate for the current environment.

The user can manually switch between personas with the help of the user interface of the electronic device, such as an array of icons assigned to different personas, or a pull-down menu with persona names. The user may want to switch to a different persona when the user changes to a different situation, or state or environment. Examples of such environment changes are: a change from work environment at the office to a leisure environment at home; and the change of the leisure environment at home to the work environment when receiving a work-related telephone call. For each change of environment, the user must change to the persona that corresponds to the new environment with the help of the user interface. For example, when a user changes to the work environment, the user may want to use the user interface to change to the corresponding professional persona. Clearly, if the user has to manually change persona many times per day, this becomes bothersome. Thus, in one embodiment the persona changes are executed automatically, without any help and intervention by the user.

In another embodiment, an automatic change to a persona can be made by the electronic device. In this embodiment an association will be defined between one or more triggers that take place within the electronic device and the persona. Such definition can be supported by a simple user interface. The definition of the triggers and the association with the persona is stored in the electronic device. The user preferably defines the trigger such that the trigger will take place with high likelihood when the user changes to a different environment with a corresponding persona. The user further preferably associates the trigger with the persona corresponding to the environment. For example, if the user wants to use a professional persona in the work environment at the office, the user may want to define a trigger equal to the connecting of the device to the network of the office and associate that trigger with the professional persona.

Referring to FIG. 1, shown is a block diagram of an electronic mobile device. The diagram is shown in a very broad overview such that it will be apparent the electronic mobile device can be many different types of devices, such as a personal digital assistant (PDA), lap top computers, cell phones, and two-way pagers. The previous list is not exhaustive and other devices may be used in accordance with other embodiments.

At present, when Bluetooth, WiFi, or other such wireless technology connects such devices to each other, they become paired. Device pairings are constantly evolving, simplifying familiar tasks and developing new possibilities. For example, your wireless-headset connects to the mobile-phone in your briefcase. In another example, a handheld electronic device, e.g., a cell phone, automatically synchronizes with a personal-computer when you walk in the office. The cell phone and personal computer can all share the same address book, schedule, and to-do list. And this appears to be just the beginning. Bluetooth wireless technology is now poised to enhance industrial automation, expand gaming possibilities and propel delivery-tracking innovation. Furthermore, such items as a Bluetooth pen, a Bluetooth briefcase, and a Bluetooth refrigerator are not only possible, but likely inevitable and real with Bluetooth wireless technology. All of these devices may be used in the different embodiments described herein and benefit therefrom.

FIG. 1 depicts an electronic mobile device 100, a memory 102, a display 104, a user interface 106, a processor 108, and a communication port 110. The electronic mobile device 100 includes a memory 102, the processor 108, the user interface 106, the communication port 110, and the display 104. The general configuration and operation of such an electronic mobile device 100 is known in the art and will not be described herein for the sake of brevity and clarity. Furthermore, common but well-understood elements that are useful or necessary are not depicted in order to facilitate a less obstructed view of the various embodiments of the present invention.

The electronic mobile device 100 is capable of connecting to many different networks and is also capable of connecting to other electronic devices. In accordance with a preferred embodiment, the communication port 110 is an interface with one or more different networks and other electronic devices. The general operation and configuration of the communication port 110 is known in the art and it is well understood that the electronic device may have multiple different communication ports for connecting and transferring data to different networks and electronic devices or may have one communication port that can connect and transfer data to one or more networks and electronic devices. For example, a user with a lap top computer is able to connect to a LAN at work and a WLAN at home. In another example, a cell phone can connect to a wireless home network or can connect to a computer. With the development of Bluetooth technology (or any other similar technology), many electronic mobile devices can connect with other electronic devices when they are within a certain proximity of each other.

Additionally the electronic device 100 can have means for determining its geographic location. In one embodiment the electronic device is equipped with a global positioning system (GPS). Alternatively the electronic device 100 can determine its approximate location through cellular network.

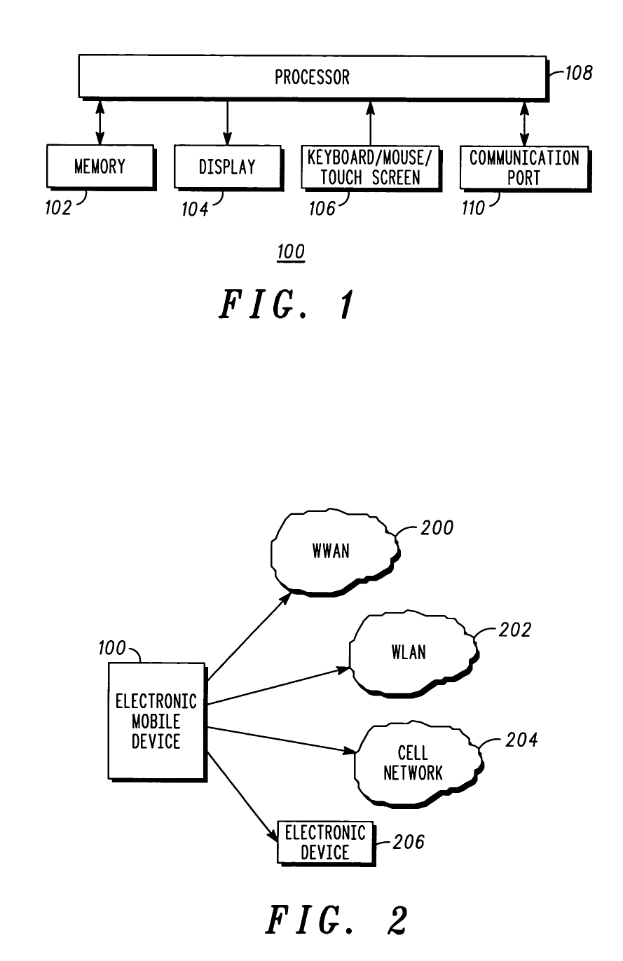

Referring to FIG. 2, shown is a representation of the electronic mobile device of FIG. 1 being able to connect to different networks. Shown is the electronic mobile device 100, a WWAN 200, a WLAN 202, a cellular network 204, and a second electronic device 206.

In accordance with a preferred embodiment the electronic mobile device 100 is able to connect to the WWAN 200, the WLAN 202, and the cellular network 204. The electronic device 100 may be able to connect to more than one of these networks at the same time. The shown networks are for representation only and as described herein in some embodiments the electronic mobile device 100 will be connecting with other devices and/or any other network that may be available. In a preferred embodiment and for purposes of this illustrative example, the electronic mobile device 100 will be connected to the WLAN 202 of the office while a user of the electronic mobile device 100 is at work, the electronic mobile device 100 will be connected to another WLAN 202 when the user is at home, and the electronic mobile device 100 will likely be connected to the cellular network 204 while the user is at any location. Additionally, the electronic device 100 can connect to a second electronic device 206. This can be done, for example, using Bluetooth technology as describe previously herein.

As seamless mobility devices become more commonplace and people start using a single electronic mobile device 100 for both home and office purposes, it is advantageous to have the same device cater to the many roles that such a user plays. For example, in one embodiment the electronic device 100 can maintain different address-books, one for the home and one for the office. Additionally, the electronic device 100 can have a different front page (or other virtual interface) at work and home thus providing the user with quick access to the applications the user is more likely to use in the different locations. In a preferred embodiment the user does not have to manually change the setup or preferences of the electronic device 100, as the electronic device 100 will change based upon the monitoring of conditions and triggers that permit the electronic device 100 to automatically effect such a change in a relevant fashion without the help or intervention of the user.

In one preferred embodiment, the electronic device 100 will have a persona that is associated with each one of a plurality of networks the electronic device 100 can connect to. When the electronic device 100 switches networks and when a different persona is associated with the detection or connection to new network, the electronic device 100 will automatically change to the persona that is associated with the new network. For example, if a user has a phone that uses the office's wireless LAN while in the office and the phone switches to the cellular network while outside the office, the phone will automatically switch personas. This avoids the need for user-initiated personal preference management that can be very cumbersome or confusing.

In this embodiment, the electronic mobile device 100 stores the definitions of one or more triggers that take place in the electronic device 100 when the device changes from one network to another. The device 100 also stores the personas associated with the one or more stored triggers. The trigger definitions can be very general, as in: the connection to any cell network 204; or the detection of any WLAN 202. Trigger definitions preferably are more precise, as in: the detection of the WLAN of the home (for example via specification of the WLAN SSID used by the home WLAN); the successful connection to the office WLAN (for example, requiring authentication and authorization with a WLAN with the specific WLAN SSID of the office system); or the connection to a specific base station in the Cell network 204.

As mentioned, some of the persona parameters correspond to the parameters defined by the profile of a PC. However many other persona parameters exist that are appropriate during the mobile use of the device or during the use of the device for telephony and other multi-media applications.

A persona parameter can be, but is not limited to:
the language used by the operating system and or the applications;
the backdrop/wall paper shown by the operating system (desktop image);
the default prompt on the display;
the display font;
the browser settings;
the browser home page;
the window appearance.
the applications for which icons appear on the desktop;
the applications in the quick access bar;
the file name of the dictionary used by the applications;
the allowed applications (for example, some applications should not be used outside the office for security reasons);
the default data set accessed by each application;
the ring tones to be used;
the ring volume;
the ring/vibrate settings
the number of rings before switching to voicemail;
the default output device (earpiece/speaker phone);
the speaker volume;
the earpiece volume;
the call forward number;
the voicemail box specification;
the auto answer preference;
the caller ID block list;
the number of telephony lines;
the mechanism of making long distance calls (when at work dial 9, when at home dial 10-10-220);
the speed dial numbers; and
the call minutes counter that counts the total telephony call duration of calls made while a persona is selected.

This is not an exhaustive list but demonstrates the many different parameters that can automatically be changed when the electronic device detects that a trigger takes place that is associated with a persona. Additionally, a persona may define parameter values for all or very few of the above parameters.

In a preferred embodiment, the electronic device 100 maintains the personas in the memory 102 of the electronic device 100; however, in other embodiments the personas (or a portion thereof) can be stored remotely. In one embodiment when a user buys a cell phone and selects a service plan a default definition of a persona can be provisioned based upon the selection of the phone and the service plan of the customer and can be modified and new personas can be added either via the phone itself or via an online website or other means that exist today for interacting and downloading data to a phone.

In a preferred embodiment, the persona can be selected based upon the type of network the user device is connected to, for example a Bluetooth network, a IP wireless local area network, a second generation (2G) cellular network, or a 2.5/3G cellular network (CDMA 2000, GSM/GPRS, UMTS). Additionally the electronic device may recognize different wired networks as well.

The device 100 can automatically change from a first persona to a second persona based upon determination by the electronic device of the current environment the device is in. Examples of the current environment the electronic device is currently in can be any of the following:
detecting a specific type of network (Cellular network, WLAN, wired Local Area Network); being connected to a specific type of network (Cellular network, WLAN, wired Local Area Network);
detecting a specific network (where the identifier of the network is specified);
being connected to a specific network (where the identifier of the network is specified);
detecting a specific network access point (using the identifier of the current cellular base station or cellular tower or the identifier of the current WLAN Access Point); being connected through a specific network access point (cellular base station, WLAN Access Point);
being at certain location;
a specified period of the day;
a specified part of the week;
being connected to a specified connected peer (other electronic device);
the presence of an incoming call;
the presence of an outgoing call; and
the current foreground application being used.

This is not an exhaustive list but examples of the different environments the electronic device 100 can be in. In accordance with the embodiments described herein, the electronic device 100 changes personas upon the detection of the current environment the electronic device is in. The electronic device 100 can detect the current environment by polling the current status of the device, thus detecting the current environment. The electronic device 100 can then change personas after the polling based upon the current environment. In an alternative embodiment, the electronic device 100 can detect the current environment base upon the detection of a trigger. When the electronic device 100 detects a trigger, the electronic device 100 will then determine the current environment based upon detection of the trigger and may change personas based upon the current environment.

Examples of different triggers or events that can take place within the electronic device 100 can be any of the following:
the detection of a specific type of network (Cellular network, WLAN, wired Local Area Network);
the detection of a specific network (where the identifier of the network is specified);
the establishment of a connection to a specific type of network;
the establishment of a connection to a specific network;
the detection of a specific network access point (cellular base station, WLAN Access Point);
the detection of entry into a specific geographic area by the electronic device;
the detection of a specified time of day;
the detection of a specified day of the week;
the identification of a specified connected peer (other electronic device);
the start of an incoming call;
the setup of an outgoing call; and
the current foreground application.

Again, this is not an exhaustive list but merely a representation of the different triggers that can be monitored or used to switch personas.

As mentioned above, the electronic device 100 being at certain location can be an environment. A preferred embodiment for this is to let the user specify geographic areas. Areas can be specified with varying levels or resolution, e.g., country, city, office (200 meters), home (50 meters), or local dining establishment (20 meters). Geographic areas can be specified by the user via the user interface, while the user is at that location (home is ‘here’ with a radius of 50 meters). Areas can also be specified by the use of coordinates. For example, a user can define a circular geographic area by the latitude and longitude of the center of the area and a length as the radius of the area. Similarly, areas can be specified as a rectangle or as a polygon. An area definition may also be downloaded from the system, for example as a collection of polygons.

The user can then combine one or more specified geographic areas and associate them with an environment. The electronic device 100 uses the location received by a GPS receiver or from a cellular network to determine whether the electronic device 100 is inside one of the specified geographic areas. When the electronic device 100 detects that it is in one of the areas it determines that it is in an environment and switches to the persona associated with the environment. Areas associated with different triggers can overlap. For example, in San Diego a user may want to specify a Spanish leisure persona, but at the San Diego office the user specifies an English professional persona. In this instance the smaller area could take preference over the larger area.

The period of the day can also be used to determine an environment associated with a persona. For example, the electronic device 100 can switch to a professional persona between 7 am and 5 pm and switch to a leisure persona between 5 pm and 7 am. Correspondingly the device could change to the appropriate persona when it determines a trigger takes place in the device 100 at 7 am or 5 pm.

The part of the week or the date can also be used to determine an environment associated with a persona. For example, the electronic device 100 can switch to a leisure persona during weekends or holidays.

The electronic device 100 can use the current IP subnet address to determine an environment associated with a persona. When the electronic device is roaming from one IP subnet to another, the electronic device can switch from the professional persona to another persona based on all or part of the IP address the device is using on the subnet.

The electronic device 100 can use the foreground application to determine an environment associated with a persona. For example, if the user is executing Turbo Tax® the device can switch to the professional persona even if the user is connected to a home network.

The identity of a connected peer electronic device 206 can be used to determine an environment associated with a persona. For example, if the electronic device 100 is connected via Bluetooth to a device 206 owned by the user's boss, the electronic device 100 will change to the professional persona, e.g., all MP3 music applications will be closed or muted and the company wall paper will be displayed on the electronic device 100.

An incoming call can be used as to determine an environment associated with a persona. For example, if the electronic device 100 is in a call from the user's boss, the caller ID of the incoming call (the boss's phone number) can be used to change to the professional persona. The corresponding trigger is the reception of the above call.

An outgoing call can be used as a trigger to change personas. For example, if the electronic device 100 is in a call that was placed to the bosses number, the outgoing call number can be used to change to a professional persona.

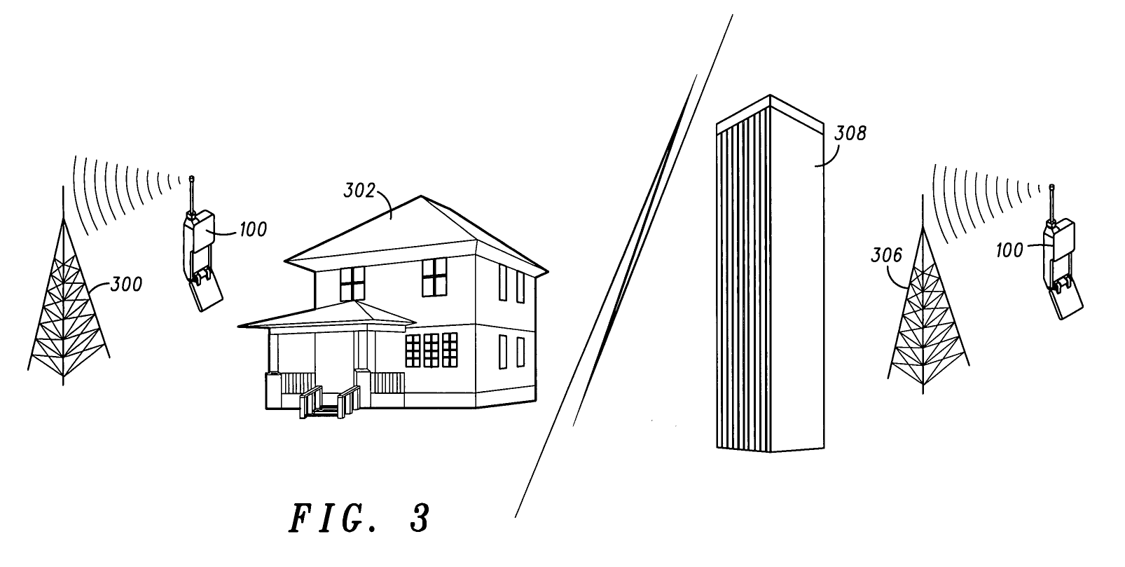

Referring next to FIG. 3, a diagram is shown of an electronic mobile device 100 connected to different cellular towers at different locations. Shown is the electronic mobile device 100, a first cellular tower 300, a home 302, a second cellular tower 306 and an office building 308.

In one embodiment a user will have an electronic mobile device 100, e.g., a cell phone that is used while at the home 302 and while at the office building 308. In the example illustrated, the electronic mobile device 100 will be connected to the first cellular tower 300 while at the home and the second cellular tower 306 while at the office building 308. Generally a user will be using the electronic mobile device 100 for different purposes while at work than while at home, thus the electronic mobile device 100 will have one persona while connected to the first cellular tower 300 and have a second persona while connected to the second cellular tower 306. For example, the user may want to have access to a different phone book, a different calendar, and have a different ring style depending upon the current location of the electronic mobile device 100.

Thus, in accordance with a preferred embodiment, the electronic mobile device 100 has a first persona, e.g., a home persona, while the user is at home 302. When the user leaves the home 302 in the morning and drives to work, the electronic mobile device 100 will detect when it is now receiving service from the second cellular tower 306 by detecting a cell identifier transmitted from that tower. The electronic mobile device 100 determines that receiving service from the second cellular tower 306 is an event that can trigger a switch in personas. The electronic mobile device 100 then will switch to a second persona, e.g., a professional persona. In accordance with a preferred embodiment, the electronic device 100 can determine the current environment of the device based upon detection of the trigger and switch to a second persona based upon the current environment.

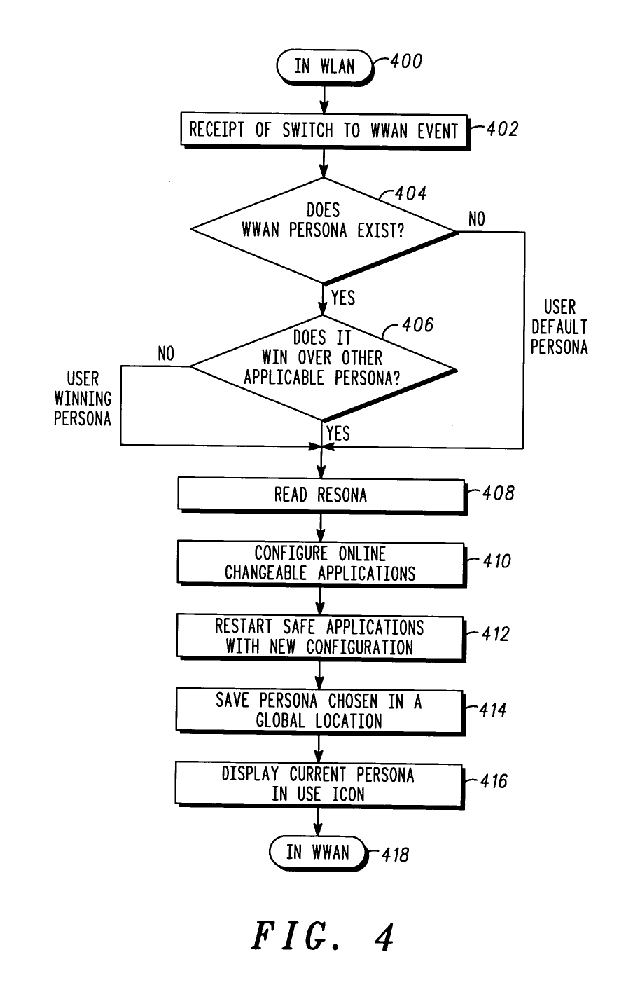

Referring next to FIG. 4, a method in accordance with one preferred embodiment is shown for switching personas of an electronic mobile device 100.

The electronic mobile device 100, also referred to herein as the electronic device 100, is connected to a WLAN in step 400. The electronic device 100 may be currently loaded for the persona relating to the WLAN. If a specific persona for the WLAN does not exist, the electronic device may be loaded with a default persona. Next in step 402 the electronic device 100 detects receipt of a switch to a WWAN event. Thus, the electronic device 100 is now connected to the WWAN rather than the WLAN.

Next in step 404 the electronic device 100 determines if a WWAN persona exists. If a WWAN persona does not exist, the electronic device will either switch to a default persona or stay in the current persona that it is in. If a WWAN persona does exist the device will determine if the WWAN persona wins over all other personas on the electronic device. Alternatively the electronic device 100 will simply switch to the WWAN persona. Thus, in one embodiment, the only determination of the persona to use will depend upon the network the electronic device 100 is connected to. In other embodiments the electronic device will use a variety of parameters to determine the proper persona. In this embodiment, the network the electronic device 100 is connected to can be one of many environments used to determine the persona the device will use, however, it is not a required environment. Other environments the electronic device 100 may use to determine which persona to use can be the period of the day, the part of the week, location, and so forth.

In step 408, once the electronic device 100 has determined the persona to use, the persona is read from memory by the electronic device 100. The persona can be read either from the memory of the electronic device or the persona can be read from a remote location via the communication port 110 and one of the networks 200, 202, 204, 206. In one embodiment, the persona is stored on a device in the network the device is currently connected to. For example, when the electronic device 100 is connected to the WLAN, the electronic device will read the persona from a preconfigured database somewhere on the WLAN.

Next in step 410, any of the online changeable applications on the electronic device 100 are configured to correspond with the currently loaded persona. The online changeable applications are any software applications and the parts of the operating system on the electronic device 100 that will not be adversely affected by changing the parameters associated with the change of the persona. Subsequently, in step 412 any software applications that may be adversely affected by changing the parameters while the application is in use are either left running with the previous persona or are shut down and restarted with the new persona configured.

Next in step 414 the loaded persona is stored in a global location such that the electronic device 100 can easily access the loaded persona. Optionally, in step 416, a persona icon can be displayed by the electronic device, to indicate to a user the persona that is currently loaded. In step 418, the WWAN persona is shown loaded onto the electronic device 100.

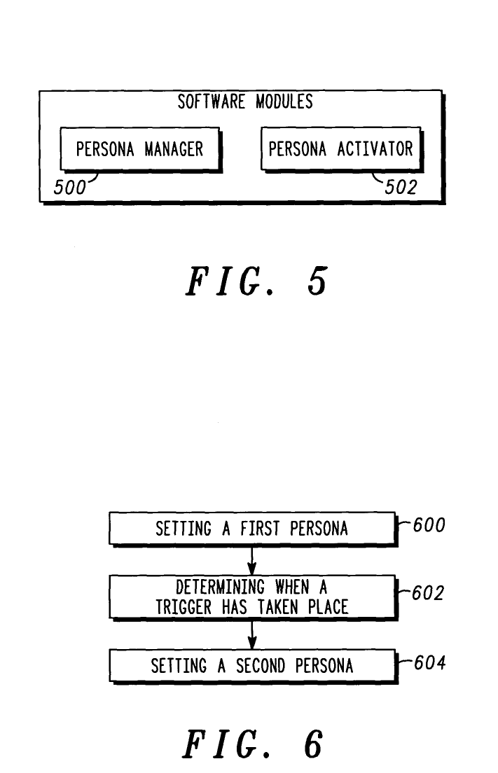

Referring next to FIG. 5, shown is a block diagram illustrating a broad overview of the structure of the software loaded on an electronic device for switching between personas. Shown is a persona manager 500 and a persona activator 502.

The persona manager 500 and the persona activator 502 may be stored in the memory 102 of the electronic device 100 or in other memory external to the electronic device 100 or any combination thereof.

The persona manager 500 provides a user interface that allows the user to set up values for the various parameters that define a persona and attach a persona to a network or any of the triggers that are associated with a persona switch. In one preferred embodiment the persona manager is located on the electronic device 100. In another embodiment, the persona manager is located on a website or on a separate computer that allows for configuration of personas. In this case, an application on the mobile device can connect to the website or the separate computer and download the created personas.

The persona activator 502 monitors what happens at the electronic device 100, for example, it determines the current environment or networks or determines the receipt of any of the triggers that are associated with a persona switch. When an event has occurred or an environment has been determined, the persona activator 502 determines if a persona switch should occur. If it is determined that persona switch should occur based upon the trigger or the current environment of the device, the application downloads or reads the corresponding persona and applies the persona parameters to the electronic device. In one embodiment the persona activator has interfaces to other applications that reside on the electronic device such that it can configure the other applications to fit the loaded persona. In one embodiment the persona activator 502 also stores the persona in a global location such that other application can use the parameters associated with the persona. The persona activator 502 can also display an icon representative of the current persona.

In an alternative embodiment, the persona activator 502 will determine the current environment by periodically polling the current status of the electronic device 100. When the electronic device 100 polls the current status of the electronic device 100 to determine the current environment, the electronic device 100 can then switch personas based upon the current environment.

In one embodiment, the persona activator 502 and the personal manager 500 are downloaded to the electronic device over a network. For example, in the case where the electronic device 100 is a mobile phone, the persona activator and the persona manager can be loaded onto the mobile phone over the cellular network. Such downloading operation is known in the art.

In a preferred embodiment, the persona activator 502 contains conflict resolution rules. As described above, the device may have more than one trigger, so conflicts may happen. The conflict resolution rules will allow the electronic device 100 to determine the correct persona to switch to. For example, the electronic device 100 may be set up to always use the professional persona when connected to the corporate network, even when it is Christmas Day. In one embodiment, each persona is associated with a priority. When the electronic device detects that two or more personas may be applicable, then it simply chooses the persona that has the higher priority. In one embodiment, the user will set the persona priorities. When no persona for a particular event is found, the persona will either remain the same or a default persona can be used. As another alternative, the user can be queried to ascertain a current persona preference.

Referring next to FIG. 6, a flow diagram is shown illustrating a method in accordance with a preferred embodiment. Shown is one method for detecting a change in the environment of the electronic device 100.

First a first persona is set 600 in the electronic device 100. The first persona can define a plurality of persona parameters such as described herein. Next it is determined when a trigger has taken place 602. The trigger can be any such trigger such as has been described herein associated with a second persona. Alternatively the electronic device 100 can determine that it is in an environment associated with a second persona. Finally the second persona is set 604 in the electronic device 100. The second persona is set 604 based upon the trigger that previously took place. Alternatively, the second persona is based upon the environment that was determined.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

1. A method of operating an electronic device without the intervention of a user comprising:
setting a first persona for the electronic device, the first persona defining the parameter values for one or more persona parameters;
determining a current environment of the electronic device; and
switching to a second persona for the electronic device based upon the current environment of the electronic device, the second persona defining different parameter values for the one or more persona parameters.

2. The method of claim 1 wherein the current environment comprises one of:
detecting a specific type of network;
being connected to a specific type of network;
detecting a specific network;
being connected to a specific network;
detecting a specific network access point;
being connected through a specific network access point;
being at certain location;
a specified period of the day;
a specified part of the week;
being connected to a specified connected peer;
the presence of an incoming call;
the presence of an outgoing call; and
the current foreground application being used.

3. The method of claim 1 wherein the first persona parameters and the second persona parameters comprise at least one of:
the language used by the operating system;
the backdrop shown by the operating system;
the default prompt on the display;
the display font;
the browser settings;
the browser home page;
the window appearance;
the applications for which icons appear on the desktop;
the applications in the quick access bar;
the file name of the dictionary used by the applications;
the allowed applications;
the default data set accessed by each application;
the number of rings before switching to voicemail;
the default output device;
the speaker volume;
the earpiece volume;
the call forward number;
the voicemail box specification;
the auto answer preference;
the caller ID block list;
the number of telephony lines;
the mechanism of making long distance;
the speed dial numbers; and
the call minutes counter that counts the total telephony call duration of calls made while a persona is selected.

4. The method of claim 1 wherein at least one of the first persona and the second persona are stored in the electronic device.

5. The method of claim 1 wherein at least one of the first persona and the second persona are stored on a remote storage medium.

6. The method of claim 1 wherein the electronic device is a mobile electronic device.

7. The method of claim 1 wherein the current environment is based upon the current network the electronic device is connected to.

8. A software program stored on a computer readable medium comprising:
a persona manager module for entering persona parameter values associated with a plurality of personas stored on the computer readable medium; and
a persona activator module for determining a current environment and activating, without user intervention, one of the plurality of personas based on the current environment.

9. The software program of claim 8 wherein the current environment comprises one of:
being connected to a specific type of network;
being connected to a specific network;
being connected through a specific network access point;
being at certain location;
a specified period of the day;
a specified part of the week;
being connected to a specified connected peer;
the presence of an incoming call;
the presence of an outgoing call; and
the current foreground application being used.

10. The software program of claim 8 wherein the plurality of personas each define the parameter values for one or more persona parameters, the persona parameters comprising at least one of:
the language used by the operating system;
the backdrop shown by the operating system;
the default prompt on the display;
the display font;
the browser settings;
the browser home page;
the window appearance.
the applications for which icons appear on the desktop;
the applications in the quick access bar;
the file name of the dictionary used by the applications;
the allowed applications;
the default data set accessed by each application;
the number of rings before switching to voicemail;
the default output device;
the speaker volume;
the earpiece volume;
the call forward number;
the voicemail box specification;
the auto answer preference;
the caller ID block list;
the number of telephony lines;
the mechanism of making long distance;
the speed dial numbers; and
the call minutes counter that counts the total telephony call duration of calls made while a persona is selected.

11. The software program of claim 8 wherein the persona activator module determines the current environment after the detection of a trigger.

12. An electronic device comprising:
means for setting a first persona for the electronic device, the first persona defining the parameter values for one or more persona parameters;
means for determining a current environment of the electronic device; and
means for switching to a second persona for the electronic device based upon the current environment of the electronic device, the second persona defining different parameter values for the one or more persona parameters.

13. The electronic device of claim 12 wherein the current environment is based upon the current network the electronic device is connected to.

14. The electronic device of claim 12 wherein the current environment is based upon being connected with a second electronic device.

15. The electronic device of claim 12 wherein the first persona and the second persona are stored on the electronic device.

16. The electronic device of claim 12 wherein at least one of the first persona and the second persona are stored on a remote storage medium.

17. The electronic device of claim 12 wherein the electronic device is a mobile electronic device.

18. The electronic device of claim 12 further comprising means for displaying a persona icon on a display of the electronic device.

19. The electronic device of claim 12 wherein the current environment comprises one of:
being connected to a specific type of network;
being connected to a specific network;
being connected through a specific network access point;
being at certain location;
a specified period of the day;
a specified part of the week;
being connected to a specified connected peer;
the presence of an incoming call;
the presence of an outgoing call; and
the current foreground application being used.

20. The electronic device of claim 12 wherein the first persona parameters and the second persona parameters comprise at least one of:
the language used by the operating system;
the backdrop shown by the operating system;
the default prompt on the display;
the display font;
the browser settings;
the browser home page;
the window appearance. the applications for which icons appear on the desktop;
the applications in the quick access bar;
the file name of the dictionary used by the applications;
the allowed applications;
the default data set accessed by each application;
the number of rings before switching to voicemail;
the default output device;
the speaker volume;
the earpiece volume;
the call forward number;
the voicemail box specification;
the auto answer preference;
the caller ID block list;
the number of telephony lines;
the mechanism of making long distance;
the speed dial numbers; and
the call minutes counter that counts the total telephony call duration of calls made while a persona is selected.
